(19) United States
(12) Patent Application Publication
(10) Pub. No.: US 2006/0258206 A1
(43) Pub. Date: Nov. 16, 2006

(54) Point-of-sale terminal

(75) Inventor: Tai-Seng Lam, Taipei City (TW)

Correspondence Address: MCNEES, WALLACE & NURICK LLC, 100 PINE STREET, P.O. BOX 1166, HARRISBURG, PA, 17108-1166, US

(73) Assignee: Flytech Technology Co., LTD., Taipei City (TW)

(21) Appl. No.: 11/189,528

(22) Filed: Jul. 26, 2005

(30) Foreign Application Priority Data
May 11, 2005 (TW) 094207587

(51) Int. Cl. H01R 13/52

(52) U.S. Cl. 439/521

(57) ABSTRACT

A point-of-sale terminal includes an outer housing, an inner box unit, and a computing hardware unit disposed in the inner box unit. The inner box unit is disposed in the outer housing, confines a receiving space, and includes a box body and a box cover. The box body defines a box opening for access to the receiving space, and includes two lateral plates, each of which is provided with a respective first engaging part. The box cover includes a top plate having two lateral edges, each of which is provided with a respective second engaging part that engages a corresponding first engaging part to interconnect the box body and the box cover such that the box cover is pivotable relative to the box body between a closed position, where the box cover closes the box opening, and an opened position, where the box cover uncovers the box opening.

### CROSS-REFERENCE TO RELATED APPLICATION

This application claims priority of Taiwanese application no. 094207587, filed on May 11, 2005.

### BACKGROUND OF THE INVENTION

1. Field of the Invention

The invention relates to a point-of-sale terminal, more particularly to a point-of-sale terminal that can facilitate maintenance and repair of computing hardware components therein.

2. Description of the Related Art

Electronic components, such as a hard disk, a power supply, etc., of a conventional point-of-sale (POS) terminal are usually mounted on a printed circuit board (PCB) so as to form an integrated module. The integrated module is then mounted securely in a plastic housing of the POS terminal. This conventional POS terminal has a disadvantage in that, when any of the components on the circuit board breaks down and has to be repaired, either the entire terminal has to be sent out for repair, or the integrated module is removed from the housing and then sent out for repair. Repair of the conventional POS terminal is thus inconvenient.

In another conventional POS terminal, a hard disk and a power supply are secured to a box cover, a computing main board is disposed in a receiving space of a box body, and the box cover is secured to the box body through the use of screw fasteners so that the hard disk, the power supply and the computing main board are all disposed in the receiving space of the box body. Hence, if it intended to inspect the hard disk, the power supply or the computing main board, the screw fasteners for interconnecting the box body and the box cover must be removed before the box cover can be detached from the box body so that visual inspection of the hard disk and the power supply is permissible. The need to remove the screw fasteners similarly results in inconvenience during maintenance and repair of the aforementioned POS terminal.

### SUMMARY OF THE INVENTION

Therefore, the object of the present invention is to provide a point-of-sale terminal that can facilitate maintenance and repair of computing hardware components therein.

According to the present invention, a point-of-sale terminal comprises an outer housing, an inner box unit, and a computing hardware unit. The inner box unit is disposed in the outerhousing, confines a receiving space, and includes a box body and a box cover. The box body defines a box opening for access to the receiving space, and includes a pair of lateral plates, each of which is provided with a respective first engaging part. The box cover includes a top plate having a pair of lateral edges, each of which is provided with a respective second engaging part. The second engaging parts engage the first engaging parts respectively to interconnect the box body and the box cover such that the box cover is pivotable relative to the box body between a closed position, where the box cover closes the box opening, and an opened position, where the box cover uncovers the box opening. The computing hardware unit is disposed in the inner box unit.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled rear perspective view of the first preferred embodiment of a point-of-sale terminal according to the present invention;

FIG. 2 is a fragmentary exploded perspective view of the first preferred embodiment;

FIG. 3 is a schematic side view of the first preferred embodiment with a second housing part and a display device removed and showing a box cover at an opened position;

FIG. 4 is a view similar to FIG. 3, but showing the box cover at a closed position;

FIG. 5 is a fragmentary schematic side view to illustrate a modification of the first preferred embodiment;

FIG. 6 is a fragmentary, partly exploded, schematic side view of the second preferred embodiment of a point-of-sale terminal according to the present invention;

FIG. 7 is a fragmentary schematic side view of the second preferred embodiment, showing a box cover thereof at a closed position;

FIG. 8 is a view similar to FIG. 7, but showing the box cover at an opened position;

FIG. 9 is a fragmentary schematic side view of the third preferred embodiment of a point-of-sale terminal according to the present invention, showing a box cover thereof at an opened position; and

FIG. 10 is a view similar to FIG. 9, but showing the box cover at a closed position.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

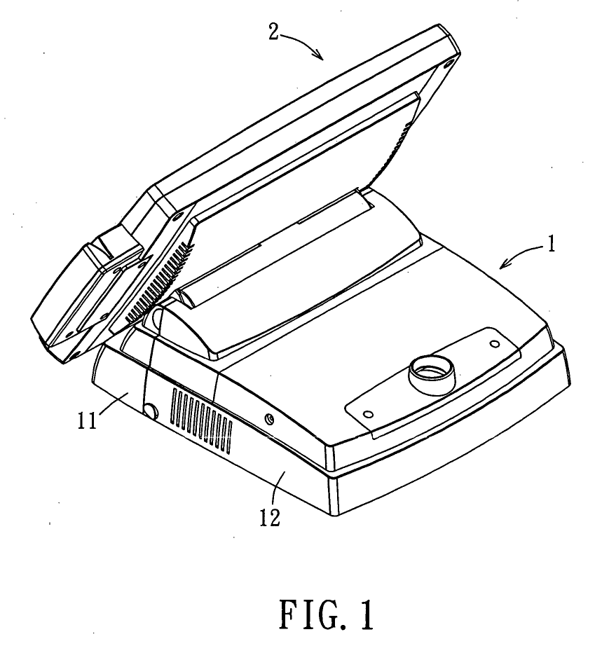

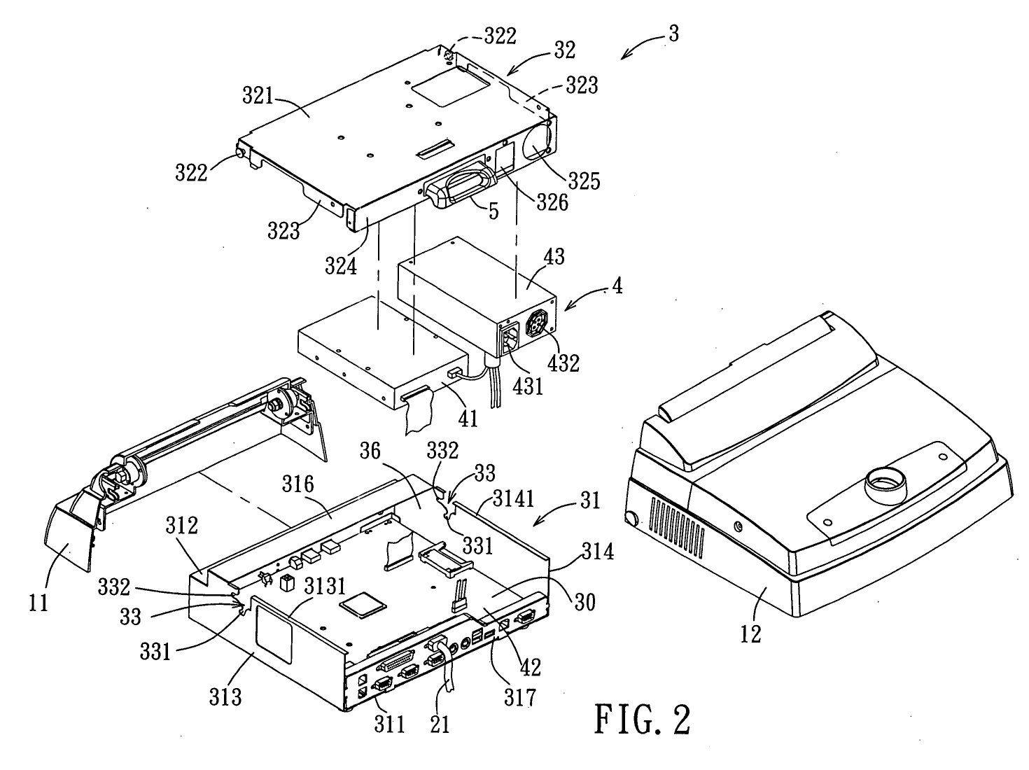

Referring to FIGS. 1 and 2, the first preferred embodiment of a point-of-sale (POS) terminal according to the present invention is shown to include an outer housing 1, a display device 2, an inner box unit 3, and a computing hardware unit 4.

The outer housing 1 includes separable first and second housing parts 11, 12 that cooperate to enclose the inner box unit 3.

The display device 2 is coupled pivotally to the first housing part 11 of the outer housing 1, and is connected electrically to the computing hardware unit 4 via a cable 21.

The inner box unit 3 is disposed in the outer housing 1, confines a receiving space 30, and includes a metal box body 31 and a box cover 32.

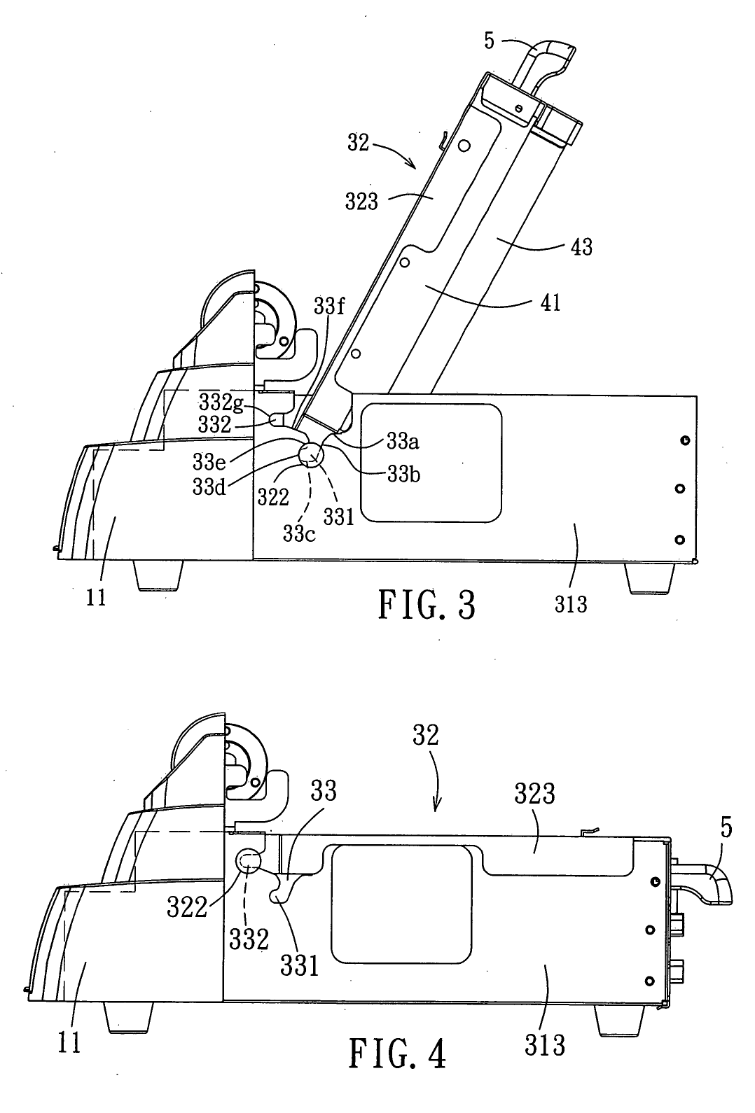

The box body 31 defines a box opening 36 for access to the receiving space 30, and includes a bottom plate 311 having a front edge and a pair of lateral edges, a front plate 312, and a pair of lateral plates 313, 314 extending upwardly from the lateral edges of the bottom plate 311. The front plate 312 has a stepped configuration, extends upwardly from the front edge of the bottom plate 311, and is connected to front edges of the lateral plates 313, 314. Each of the lateral plates 313, 314 has a top edge 3131, 3141. The front plate 312 includes a top plate part 316 connected to front parts of the top edges 3131, 3141 of the lateral plates 313, 314. Each of the lateral plates 313, 314 is further provided with a respective first engaging part 33. In this embodiment, each first engaging part 33 is formed as a groove that is indented from the top edge 3131, 3141 of the respective lateral plate 313, 314 and that is disposed proximate to the front plate 312. With further reference to FIG. 3, each of the grooves has a groove bottom that includes a first segment (33a) that extends forwardly, a second segment (33b) that curves downwardly from the first segment (33a), a third segment (33c) that extends forwardly from the second segment (33b), a fourth segment (33d) that curves forwardly and upwardly from the third segment (33c), a fifth segment (33e) that curves rearwardly and upwardly from the fourth segment (33d), a sixth segment (33f) that extends forwardly from the fifth segment (33e), and a seventh segment (33g) that curves forwardly and upwardly from the sixth segment (33g). The first to seventh segments (33a to 33g) configure each of the first engaging parts 33 with a first pivot retaining slot 331 and a second pivot retaining slot 332 disposed in front of and above the first pivot retaining slot 331. The box body 31 further includes a connector-mounting plate 317 (see FIG. 2) extending between the lateral plates 313, 314 at a rear edge of the bottom plate 311 and having a set of electrical connectors mounted thereon.

Referring once again to FIG. 2, the box cover 32 includes a top plate 321 and a rear plate 324. The top plate 321 has a pair of lateral edges 323 that are bent to extend downwardly. Each of the lateral edges 323 is provided with a respective second engaging part 322. In this embodiment, each second engaging part 322 is disposed at a recessed front end of the respective lateral edge 323, and is formed as a pivot axle to be movably retained in one of the first and second pivot retaining slots 331, 332 of a respective one of the first engaging parts 33. In particular, the second engaging parts 322 engage the first engaging parts 33 respectively to interconnect the box body 31 and the box cover 32 such that the box cover 32 is pivotable relative to the box body 31 between a closed position (see FIG. 4), where the box cover 32 closes the box opening 36, and an opened position (see FIG. 3), where the box cover 32 uncovers the box opening 36. The rear plate 324 extends downwardly from a rear edge of the top plate 321, and is formed with a fan hole 325 and a socket hole 326.

The inner box unit 3 further includes a handle 5 mounted on the rear plate 324 of the box cover 32.

The computing hardware unit 4 is disposed in the inner box unit 3, and includes a data storage device 41, a power supply module 43 and a computing main board 42 in this embodiment. In the preferred embodiment, the data storage device 41 is a hard disk, and the power supply module 43 has a fan vent 432 and a power socket 431. The top plate 321 of the box cover 32 has a bottom side, and the data storage device 41 and the power supply module 43 are secured to the bottom side of the top plate 321 with the use of screws. Preferably, the data storage device 41 and the power supply module 43 abut against the rear plate 324 of the box cover 32, and the fan vent 432 and the power socket 431 of the power supply module 43 are registered with the fan hole 325 and the socket hole 326 in the rear plate 324 of the box cover 32, respectively. The computing main board 42 is mounted to the box body 31 in the receiving space 30, and is connected electrically to the data storage device 41 and the power supply module 43 through the use of cables. The computing main board 42 is further connected electrically to the connectors on the connector-mounting plate 317 of the box body 31.

Referring to FIGS. 3 and 4, due to the pivot connection between the box cover 32 and the box body 31, the data storage device 41 and the power supply module 43 are disposed in the receiving space 30 of the inner box unit 3 when the box cover 32 is at the closed position (see FIG. 4), and are moved out of the receiving space 30 when the box cover 32 is at the opened position (see FIG. 3). Since the second engaging parts 322 are disposed at the recessed front ends of the lateral edges 323 of the top plate 321 of the box cover 32, when the second engaging parts 322 are slid into the first pivot retaining slots 331 of the first engaging parts 33, each lateral edge 323 of the top plate 321 can abut against the first segment (33a) of the groove bottom of an adjacent first engaging part 33 such that the box cover 32 is held at the opened position, in which the box cover 32 inclines upwardly relative to the box body 31, as shown in FIG. 3. On the other hand, when the box cover 32 is operated to move the second engaging parts 322 from the first pivot retaining slots 331 to the second pivot retaining slots 332 of the first engaging parts 33, the box cover 32 is pivoted to move to the closed position, in which the box cover 32 lies in a horizontal state relative to the box body 31, as shown in FIG. 4. Moreover, since the first engaging parts 33 are indented from the top edges 3131, 3141 of the lateral plates 313, 314, the second engaging parts 322 can be removed from the first engaging parts 33 through a simple lifting action of the box cover 32 when it is desired to detach the box cover 32 from the box body 31. Furthermore, since the data storage device 41 and the power supply module 43 are secured to the box cover 32 to form an independent module in this embodiment, if replacement or repair of the data storage device 41 or the power supply module 43 is desired, the box cover 32 can be easily removed from the box body 31 as described hereinabove, thereby eliminating the need to bring the entire inner box unit 3 of the POS terminal to a service center. In addition, when it is only desired to conduct a visual inspection of the data storage device 41 and the power supply module 43, since the box cover 32 can be pivoted to the opened position, there is no need to detach-the box cover 32 from the box body 31.

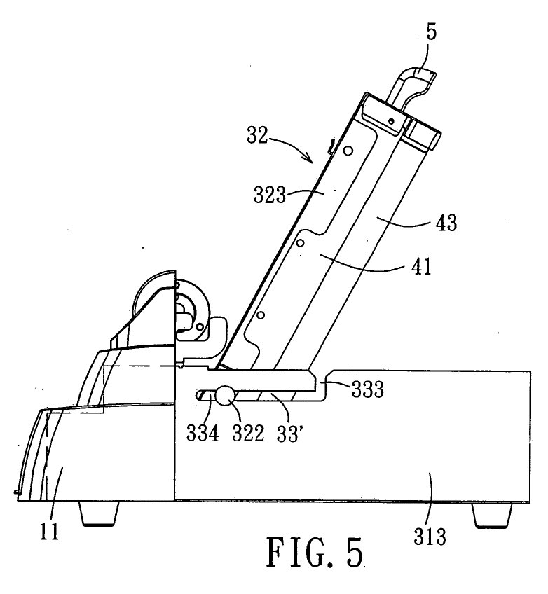

Referring to FIG. 5, a modification of the first preferred embodiment is shown, which differs primarily in the configuration of the first engaging parts 33′. In particular, each first engaging part 33′ includes a first groove part 333 that extends downwardly from the top edge of the respective one of the lateral plates (only the lateral plate 313 is visible), and a second groove part 334 that intersects the first groove part 333 and that extends parallel to the top edge of the respective one of the lateral plates.

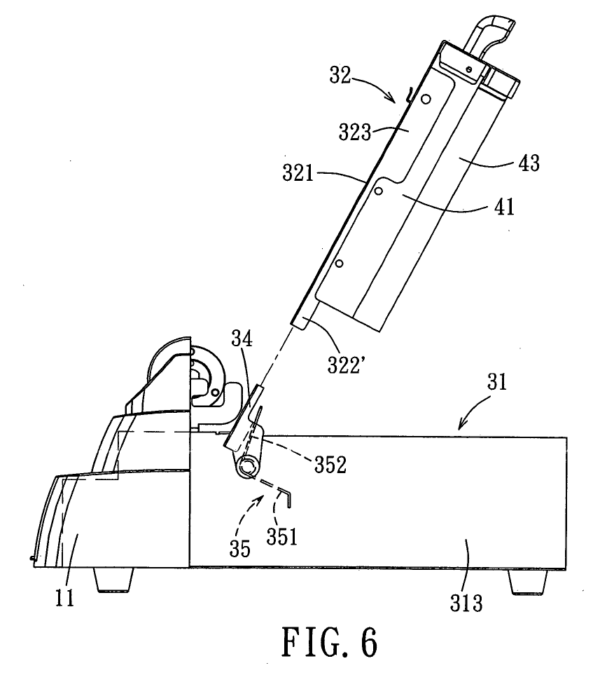

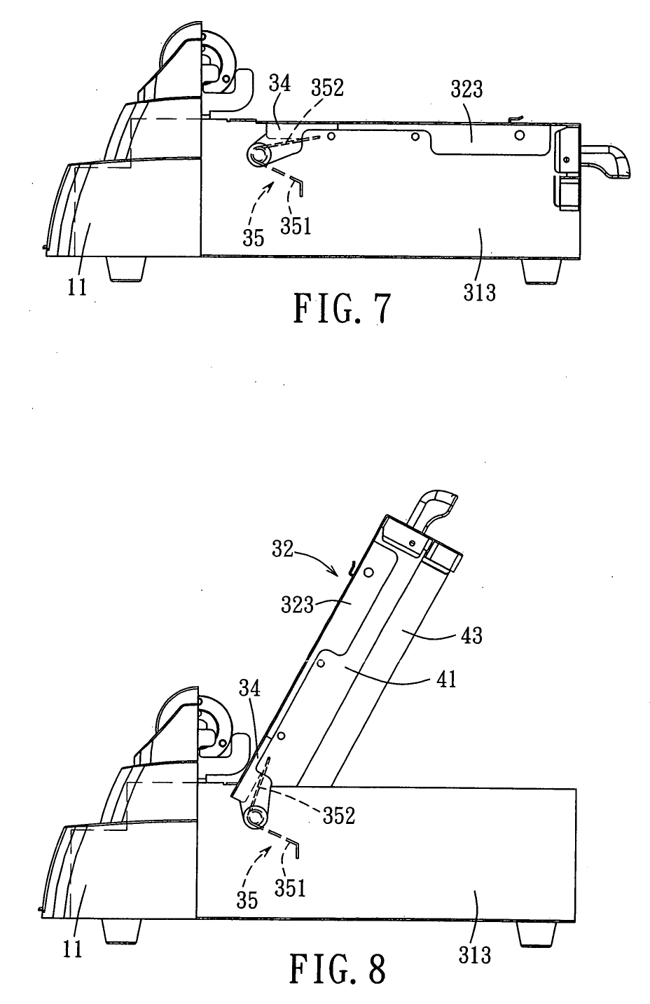

FIGS. 6 to 8 illustrate the second preferred embodiment of a point-of-sale terminal according to the present invention. Unlike the previous embodiment, each of the first engaging parts includes a coupling plate 34 that is connected pivotally to the respective one of the lateral plates (only the lateral plate 313 is visible). Each of the second engaging parts is formed as a side plate 322′ that extends from the respective one of the lateral edges 323 of the top plate 321 and that is secured to the coupling plate 34 of the respective one of the first engaging parts through the use of screw fasteners or other suitable securing means. As a result, the box cover 32 can be pivoted relative to the box body 31 between a closed position (see FIG. 7) and an opened position (see FIG. 8). Each of the first engaging parts further includes a torsion spring 35 having a first spring arm 352 connected to the coupling plate 34, and a second spring arm 351 connected to the respective one of the lateral plates, e.g., the lateral plate 313, for providing a biasing force for urging the box cover 32 to the opened position. In this embodiment, a releasable latching mechanism (not shown) may be provided between the box body 31 and the box cover 32 so that the box cover 32 can be retained at the closed position, with the torsion springs 35 accumulating a restoring force. Therefore, when it is desired to move the box cover 32 to the opened position, the latching mechanism is released so that the box cover 32 can pivot to the opened position by virtue of the restoring force accumulated by the torsion springs 35.

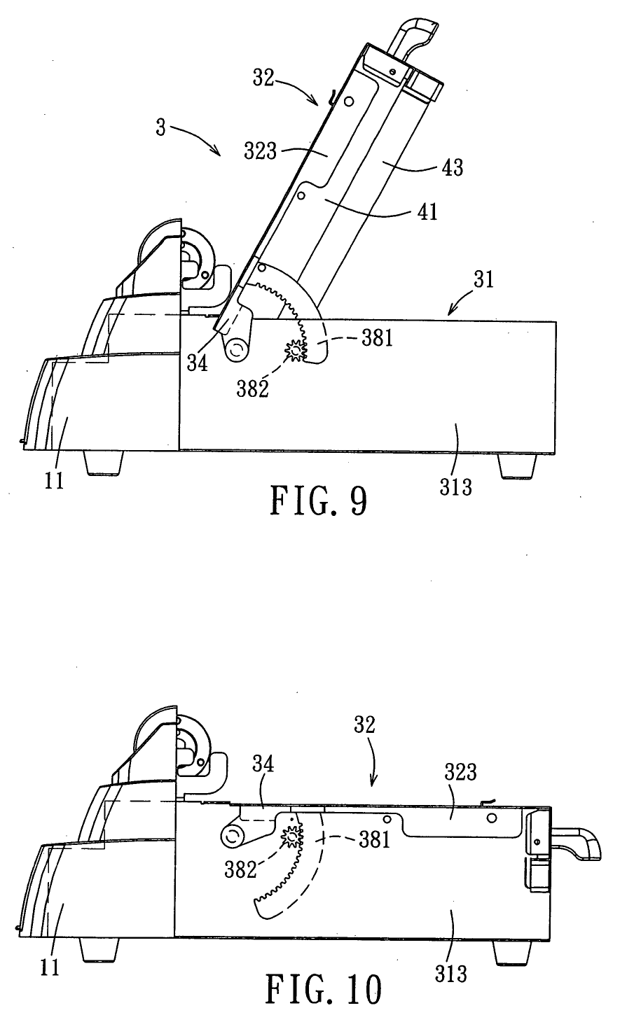

FIGS. 9 and 10 illustrate the third preferred embodiment of a point-of-sale terminal according to this invention. When compared with the embodiment of FIGS. 6 to 8, instead of the torsion spring 35, each first engaging part further includes a curved rack 381 and a pinion 382. The pinion 382 is mounted rotatably on the respective one of the lateral plates (only the lateral plate 313 is visible) inside the box body 31. The curved rack 381 extends downwardly from the coupling plate 34 into the box body 31 and meshes with the pinion 382. When the box cover 32 is pivoted relative to the box body 31, an effect similar to hydraulic transmission is achieved through meshing between the pinion 382 and the rack 381.

In the second and third preferred embodiments, it is required to remove the fasteners that secure the side plates 322′ to the coupling plates 34 when it is desired to detach the box cover 32 from the box body 31. In addition, the second and third preferred embodiments may be modified by providing a bridging plate (not shown) that extends between and that is connected to the coupling plates 34. In this case, the box cover 32 may be secured to the bridging plate instead of the coupling plates 34.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A point-of-sale terminal comprising:
an outer housing;
an inner box unit disposed in said outer housing, confining a receiving space, and including
a box body defining a box opening for access to said receiving space, and including a pair of lateral plates, each of which is provided with a respective first engaging part, and
a box cover including a top plate having a pair of lateral edges, each of which is provided with a respective second engaging part,
said second engaging parts engaging said first engaging parts respectively to interconnect said box body and said box cover such that said box cover is pivotable relative to said box body between a closed position, where said box cover closes said box opening, and an opened position, where said box cover uncovers said box opening; and
a computing hardware unit disposed in said inner box unit.

2. The point-of-sale terminal as claimed in claim 1, wherein said top plate of said box cover has a bottom side, said computing hardware unit including a data storage device and a power supply module, at least one of which is secured to said bottom side of said top plate;
said at least one of said data storage device and said power supply module being disposed in said receiving space of said inner box unit when said box cover is at the closed position, and being moved out of said receiving space when said box cover is at the opened position.

3. The point-of-sale terminal as claimed in claim 2, wherein said computing hardware unit further includes a computing main board mounted to said box body and connected electrically to said data storage device and said power supply module.

4. The point-of-sale terminal as claimed in claim 2, wherein:
said power supply module has a fan vent and a power socket;
said box cover further including a rear plate extending from said top plate and formed with a fan hole and a socket hole that are registered with said fan vent and said power socket of said power supply module, respectively.

5. The point-of-sale terminal as claimed in claim 1, wherein said box body further includes a connector-mounting plate extending between said lateral plates and having a set of electrical connectors mounted thereon.

6. The point-of-sale terminal as claimed in claim 1, wherein said inner box unit further includes a handle mounted on said box cover.

7. The point-of-sale terminal as claimed in claim 1, further comprising a display device coupled to said outer housing and connected electrically to said computing hardware unit.

8. The point-of-sale terminal as claimed in claim 7, wherein said outer housing includes separable first and second housing parts that cooperate to enclose said inner box unit, said display device being coupled pivotally to said first housing part.

9. The point-of-sale terminal as claimed in claim 1, wherein:
each of said lateral plates has a top edge, each of said first engaging parts being formed as a groove that is indented from said top edge of the respective one of said lateral plates;
each of said second engaging parts being formed as a pivot axle on the respective one of said lateral edges of said top plate and being movably retained in the respective one of said first engaging parts.

10. The point-of-sale terminal as claimed in claim 9, wherein each of said first engaging parts has a groove bottom that includes:
a first segment that extends forwardly;
a second segment that curves downwardly from said first segment;
a third segment that extends forwardly from said second segment;
a fourth segment that curves forwardly and upwardly from said third segment;
a fifth segment that curves rearwardly and upwardly from said fourth segment;
a sixth segment that extends forwardly from said fifth segment; and
a seventh segment that curves forwardly and upwardly from said sixth segment;
said first to seventh segments configuring each of said first engaging parts with a first pivot retaining slot and a second pivot retaining slot disposed in front of and above said first pivot retaining slot.

11. The point-of-sale terminal as claimed in claim 9, wherein each of said first engaging parts includes a first groove part that extends downwardly from said top edge of the respective one of said lateral plates, and a second groove part that intersects said first groove part and that extends parallel to said top edge of the respective one of said lateral plates.

12. The point-of-sale terminal as claimed in claim 1, wherein each of said first engaging parts includes a coupling plate connected pivotally to the respective one of said lateral plates.

13. The point-of-sale terminal as claimed in claim 12, wherein each of said second engaging parts is formed as a side plate that extends from the respective one of said lateral edges of said top plate and that is secured to said coupling plate of the respective one of said first engaging parts.

14. The point-of-sale terminal as claimed in claim 12, wherein each of said first engaging parts further includes a torsion spring having a first spring arm connected to said coupling plate, and a second spring arm connected to the respective one of said lateral plates, said torsion spring providing a biasing force for urging said box cover to the opened position.

15. The point-of-sale terminal as claimed in claim 12, wherein each of said first engaging parts further includes:
a pinion mounted rotatably on the respective one of said lateral plates; and
a curved rack extending downwardly from said coupling plate and meshing with said pinion.
